(19) United States
(12) Patent Application Publication
(10) Pub. No.: US 2006/0164255 A1
(43) Pub. Date: Jul. 27, 2006

(54) Laundry alert system and method

(76) Inventors: Chris Humbert, Crown Point, IN (US); David Allen Atkinson, Raleigh, NC (US); Chad Allen Ellis, Crisman, IL (US); David Martin Odle, Fort Wayne, IN (US); Michael J. Nickelson, Woburn, MA (US)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 10/903,372

(22) Filed: Jul. 30, 2004

Related U.S. Application Data
(60) Provisional application No. 60/491,341, filed on Jul. 30, 2003.

(51) Int. Cl. G08B 21/00; G08B 1/00

(52) U.S. Cl. 340/679; 340/309.16; 340/531

(57) ABSTRACT

A method and apparatus for alerting a user of the status of an appliance includes a controller that is coupled to a telephone network and a keypad to permit the entry of a numeric sequence and to communicate the numeric sequence to the controller. The keypad is coupled to the control circuit of the appliance to determine whether the appliance has commenced a requested task, to determine if the requested task has been completed, and to provide the numeric sequence to the controller in response to determination that the requested task has been completed. The controller initiates a call over the telephone network based upon the numeric sequence to provide notification of the completion of the requested tasks by the appliance.

### RELATED APPLICATIONS

This application claims the benefit of U.S. Provisional Patent Application Ser. No. 60/491,341, filed Jul. 30, 2003 titled “LAUNDRY ALERT”, the disclosure of which is expressly incorporated by reference herein.

### BACKGROUND AND SUMMARY OF THE INVENTION

The present invention relates to a method and apparatus for alerting a user of a status of an appliance, and in particular to the status of an appliance which is typically used by a plurality of users but which is associatable with one user at a time of the plurality of users, such as a laundry appliance.

It is common to have one or more appliances shared by a plurality of users. One example of the sharing of one or more appliances by a plurality of users is the use of laundry appliances, such as washers and dryers, in a college dormitory, apartment complex, or Laundromat. Typically, a user of such laundry appliances places his or her clothing in the appliance and configures the appliance to clean and/or dry the clothing. The user typically then leaves the proximity of the appliance due to the time normally associated with the cleaning and/or drying of the clothes and returns at a later time to retrieve the clothing.

A plurality of problems exist with this situation assuming that the user does not return approximately when the laundry appliance completes cleaning and/or drying the clothes. First, the utility of the appliance is not being maximized because a second user is unable to utilize the now idle appliance due to the clothing of the first user still being in the appliance. Second, a second user may remove the clothing of the first user from the appliance in order to utilize the appliance. Often the second user does not fold the clothing or otherwise care for the clothing in a manner consistent with the desires of the first user. As such, the clothing may be wrinkled, soiled, and/or in the case of being removed from a washing machine be left in a pile of wet clothing somewhere in the room instead of being placed in a dryer. Other examples of the sharing of one or more appliances by a community of users also exist.

The present invention provides an alert system which alerts a user of the status of an appliance associated with the user.

In one exemplary method, a method of alerting a user over a network of a status of an appliance, the appliance being available to a plurality of users for use is provided. The method comprising the steps of providing a controller operably coupled to the network and a user association device operably coupled to the controller, the user association device being associated with the appliance and operably coupled to the appliance; detecting a commencement of a requested task associated with the appliance with the user association device; prompting the user with the user association device for user contact information in response to the detection of the commencement of the requested task associated with the appliance; receiving user contact information through an input of the user association device; detecting a completion of the requested task by the appliance with the user association device; and communicating to the user over the network the completion of the requested task, the user being contacted through the controller based in part on the user contact information.

In one exemplary embodiment, an apparatus for use with an appliance, the appliance being available for use by a plurality of users is provided. The apparatus being configured to alert a current user of the appliance over a telephone network of a status of the appliance, the appliance including a control circuit which indicates the status of the appliance. The apparatus comprising a controller adapted to be operably coupled to the telephone network; a keypad unit operably coupled to the controller, the keypad unit including a keypad configured to permit the entry of a numeric sequence and a memory designed to store the numeric sequence, the keypad unit configured to communicate the numeric sequence to the controller; wherein the keypad unit is further operably coupled to the control circuit in the appliance and is configured to determine whether the appliance has commenced a requested task and to determine if the requested task has been completed, the keypad unit being further configured to prompt the user for entry of the numeric sequence in response to appliance commencing the requested task and to provide the numeric sequence to the controller in response to a determination that the requested task has been completed by the appliance; and wherein the controller, in response to receipt of the numeric sequence from the keypad unit, is configured to initiate a call over the telephone network based on the numeric sequence and to provide the current user a notification of the completion of the requested task by the appliance during the call.

In a further exemplary embodiment, an apparatus for use with an appliance, the appliance being available for use by a plurality of users is provided. The apparatus being configured to alert a current user over a network of a status of the appliance. The apparatus comprising a controller adapted to be operably coupled to a network; a user association device, the user association device being associated with and operably coupled to the appliance and being operably coupled to the controller, and wherein the user association device is configured to prompt the current user of the appliance for a user contact input including user contact information upon detection of a commencement of a requested task by the appliance, to make the received user contact information available to the controller, and to provide an indication of the completion of the requested task by the appliance to the controller, the controller being configured to send a communication to the current user over the network based on the user contact information in response to the received indication of the completion of the requested task, the communication being configured to alert the user of the completion of the requested task by the appliance, and to resend the communication to the user in the absence of an acknowledgement of the communication from the user.

In another exemplary embodiment, apparatus for use with an appliance, the appliance for use by a plurality of users is provided. The apparatus configured to alert a current user over a network of a status of the appliance. The apparatus comprising a controller adapted to be operably coupled to the network; and a user association device operably coupled to the controller, the user association device being configured to prompt the user of the appliance for an input, the input being indicative of a network identifier for the user, the user association device being further configured to provide an indication of a completion of a requested task to the controller; wherein the controller is configured based on the input and the received indication of the completion of the requested task to initiate a first communication to the user over the network to alert the user of the status of the appliance and is further configured to send a second communication to the user over the network in response to the reception of a request from the user to send the second communication.

### BRIEF DESCRIPTION OF THE DRAWINGS

FIG. 1 is a diagrammatic representation of a college laundry room having a plurality of laundry appliances and an exemplary laundry alert system of the present invention, the laundry alert system including a controller operably coupled to a network and plurality of user association devices;

FIG. 2 is a diagrammatic representation of an exemplary laundry alert system of FIG. 1 for use with a telephone network;

FIG. 3 is an exemplary embodiment of the user association device of FIG. 2, the illustrated user association device being a keypad unit having a membrane keypad to input data, such as a telephone number;

FIG. 4 is a diagrammatic representation of an exemplary embodiment of the keypad unit shown in FIG. 3;

FIG. 5 is a first schematic diagram of an exemplary embodiment of the keypad unit shown in FIG. 3;

FIG. 6 is a second schematic diagram of an exemplary embodiment of the keypad unit shown in FIG. 3;

FIG. 7 is an exemplary embodiment of the laundry alert system of FIG. 1 having a series of keypad units, similar to the keypad units shown in FIG. 3, that are each connected to a network and each keypad associated with a given laundry appliance, such as washers and/or dryer units;

FIG. 8 is a first schematic diagram of an exemplary embodiment of the controller of FIG. 2;

FIG. 9 is a second schematic diagram of an exemplary embodiment of the controller of FIG. 2;

FIG. 10 is a flowchart of an exemplary embodiment of a method of alerting a user of the status of a laundry appliance;

FIG. 11 is a flowchart of an exemplary embodiment of the Prompt and Capture Data Subroutine shown in FIG. 10; and

FIG. 12 is a flowchart of an exemplary embodiment of the User Notification Subroutine shown in FIG. 10;

### DETAILED DESCRIPTION

While the invention is susceptible to various modifications and alternative forms, exemplary embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

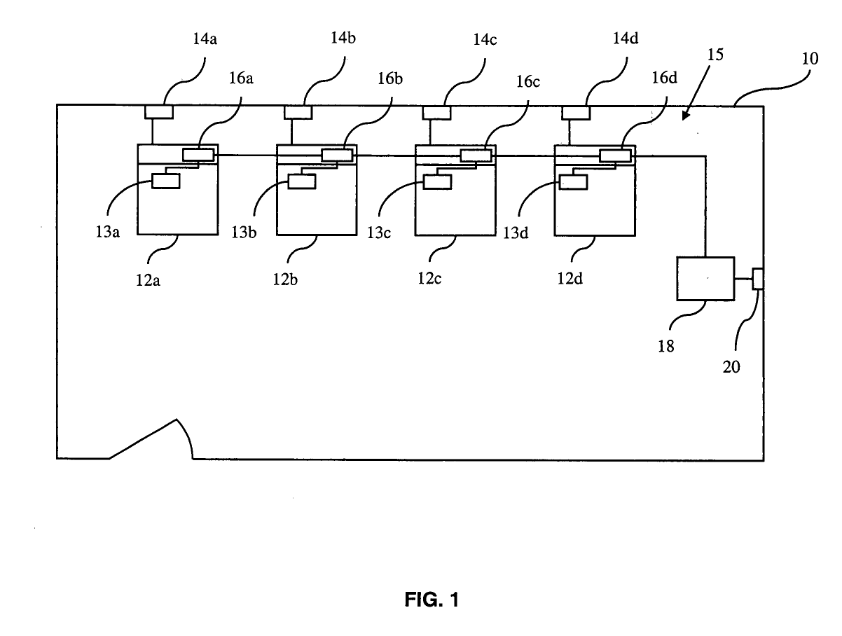

Referring to FIG. 1, a laundry room 10 of a college dormitory is shown. Laundry room 10 includes a plurality of laundry appliances 12, appliances 12a, 12b, 12c, and 12d being shown, such as washing machines and/or dryers. Each appliance 12, as is well known in the art, is configured to be coupled to a respective wall outlet 14, wall outlets 14a, 14b, 14c, 14d being shown, to power operation of appliances 12a, 12b, 12c, 12d. Further, each appliance 12 is configured to perform one or more tasks, such as for a washing machine: wash gentle, wash regular, selection of water temperature, rinse, etc., in response to a selection by a user. Examples of operational modes for a clothes dryer include: timed dry, permanent press, gentle cycle, high heat, etc.

Appliances 12 are typically used by a plurality of users and no one appliance 12 is assigned or otherwise associated with a single user, but rather each appliance 12 is available on a first come first serve basis. Further, it is typical for each appliance 12 to be configured to operate only in response to the user providing a predetermined amount of money or other payment form. Typical laundry appliances include a coin slot, dollar bill feeder, and/or card reader configured to accept coins, paper currency, and/or previously purchased credits, respectively.

In use a current user of appliance 12 approaches appliance 12 and requests for appliance 12 to commence a task. In the case of laundry appliances, such tasks may include a wash cycle, a rinse cycle, a spin cycle, drying cycle, and/or combinations thereof such as a wash cycle followed by a spin cycle, followed by a rinse cycle, and followed by a spin cycle, and one or selectable parameters such as water temperature, time, speed, and/or heat level.

As stated previously, a problem often associated with a plurality of users sharing a limited number of appliances is that a current user of an appliance often leaves the proximity of the appliance and then a subsequent second user is unable to utilize the appliance upon completion of the tasks requested by the first user. In the case wherein the appliance is a laundry appliance, it is also possible that a second user will simply handle the clothing of the first user in a manner somewhat inconsistent with the manner it would have been handled by the first user, in order for the second user to utilize the laundry appliance.

Laundry alert system 15 is configured to associate a first user with at least one of a respective appliances 12a, 12b, 12c, 12d and to notify the first user when the at least one respective appliance 12a, 12b, 12c, 12d has completed the tasks requested by the first user. Laundry alert system 15 includes a plurality of user association devices (“UAD”) 16a, 16b, 16c, 16d and a controller 18. Each user association device is associated with a respective appliance 12a, 12b, 12c, 12d and is configured to receive an input from a user in response to a prompt from system 15. Once the input is received from the user the user is associated with the appliance 12.

In one embodiment, user association device 16 is a separate device having a separate housing from appliance 12 and is either coupled to appliance 12 or positioned proximate to appliance 12. In another embodiment, user association device 16 is integrated with appliance 12.

User association device 16 is further operably coupled to a control circuit of electronics 13 of appliance 12. As explained in more detail below, user association device 16 monitors or otherwise detects a condition of electronics 13 to determine if appliance 12 is in use or commenced a requested task or has completed a requested task. In one example, user association device is further able to detect a completed cycle of appliance 12 in addition to whether appliance 12 is in use or not. In one example, user association device 16 can detect whether appliance 12 is in use or not by simply monitoring the voltage of a diagnostic signal on a diagnostic port located in the back of the appliance.

As stated above, appliance 12 is not associated with a user until the user provides an input to a prompt from system 15, the input providing contact information about the user. In one example, the input is a numeric sequence corresponding to a contact for the user, such as a telephone number. In one example, the telephone number is an extension number, a local number, or a ten-digit number including an area code. In one embodiment, laundry alert system 15 is capable of distinguishing whether the received input is an extension number on a local network or a number requiring access to an outside line. Laundry alert system 15 may be configured to dial a prefix such as “9” to access the outside line. Other exemplary contacts for the user include e-mail addresses, network addresses such as IP addresses, and pager numbers.

In another example, the input is a user identification code which is used to retrieve user contact information from a database (not shown). It should be understood that the database can be locally accessible by laundry alert system 15 or accessible across a network. Exemplary user identification codes include student ID numbers, apartment numbers, social security numbers, and user names.

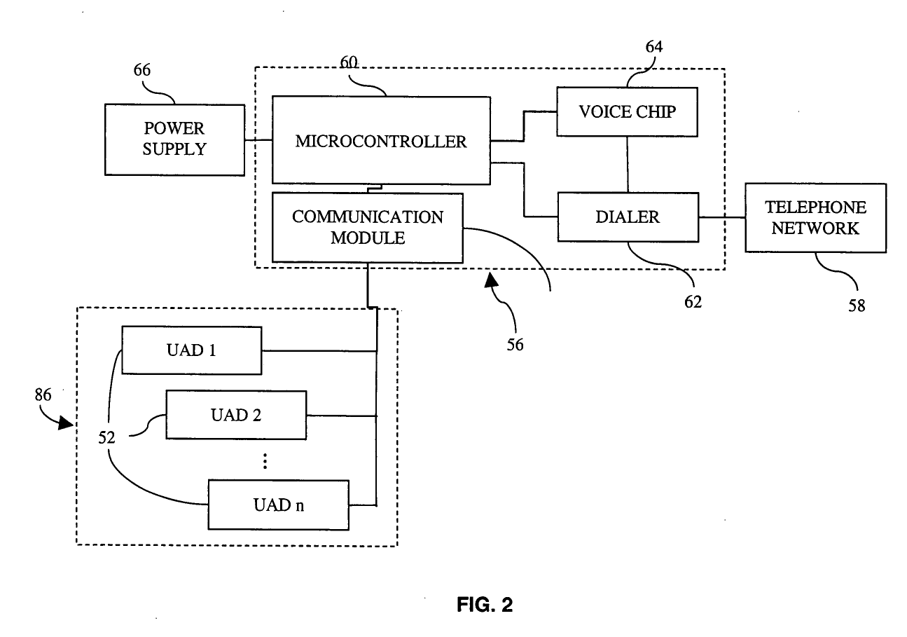

Referring to FIG. 2, an exemplary alert system 50 for alerting a user of a status of an appliance, such as a clothes washer or clothes dryer, is shown. Alert system 50 includes a plurality of user association devices 52 forming a user association device array 54 and a controller 56. As stated above each user association device is associated with a respective appliance. Controller 56 is operably coupled to the user association devices 52 to receive status information and user inputs entered into user association devices 52. It should be understood that the discussion above concerning user association devices 16 and controller 18 is applicable to the discussion of user association devices 52 and controller 56.

Controller 56 is configured to interface with a telephone network 58 and includes a microcontroller 60 that is configured to interact with a dialer 62 and a voice chip 64. Controller 56 is operably coupled to a power supply 66 which in turn is coupled to a AC wall outlet (not shown) and provides and regulates the voltage required to energize the controller 56. In one example, power supply 66 is included in a housing with the components of controller 56 and includes a DC transformer to convert the AC power to DC. In another example, power supply 66 is a wall wart and controller 56 includes a cable or other connection to the wall wart. In alternative embodiments, other power sources could be utilized to provide power to controller 56, such as a battery or similar device or a power injector.

Controller 56 is operably coupled to telephone network 58 through dialer 62. The connection to telephone network 58 allows controller 56 to communicate over the telephone network 58 with the user. The connection between controller 56 and telephone network 58 may be a wired connection or a wireless connection completed through the use of a wireless transmitter configured to send data through a cellular telephone network or other wireless network. In either the wired or wireless telephone embodiments, the controller 56 can be configured to dial an outside access number or prefix, such as a “9,” in order to complete telephone calls outside the local or campus telephone system as well as those within the local or campus telephone system. Other wired or wireless networks may also be used such as local area networks, such as an Ethernet network or a token ring network, wide area networks, connections to the Internet or an Intranet, other suitable networks or methods of connecting controller 56 to a remote user.

In one exemplary embodiment, user association device array 54 includes up to two hundred fifty-six (256) user association devices 52 that are each operably coupled to controller 56, with each user association device 52 associated with a specific laundry appliance. In one embodiment, utilizing user association device array 54, each user association device 52 receives power from controller 56.

In one example, a multi-wire cable runs from controller 56 through every user association device 52. The multi-wire cable includes at least two communication lines for supporting communication between controller 56 and user association devices 52, such as a RS 485 network and at least one power line delivering power. The power delivered over the at least one power line can be from controller 56, one or more of user association devices 52, or from a power injector. The power injector may be a stand alone device or integrated into one of controller 56 and user association devices 52.

In one embodiment, utilizing the user association device array 54, each user association device 52 receives power from controller 56. In another embodiment, utilizing the user association device array 54, each user association device 52 has a dedicated power source that is either self-contained, such as a battery, or converts power supplied by an electrical outlet through the use of a transformer (not shown) or the like. By having each user association source, it is possible to maintain the operation of some user association devices 52 even if power to others of the user association devices 52 is lost.

While the exemplary embodiment of user association devices 52 shown details an external or add-on unit that can be configured to work with existing laundry appliances with only negligible intrusion into the factory electronics, in another embodiment either all or a portion of the components of the laundry alert system 50 or user association device 52 can be integrated into the laundry appliance itself. For instance, user association device 52 can be configured to reside within the laundry appliance or user association device 52 and controller 56 could be configured to reside within the laundry appliance. In addition, the circuitry of laundry alert system 50 or user association device 52 or controller 56, or any combination thereof, can be configured to utilize the same power source utilized by the laundry appliance, or configured to draw power from the circuitry of the laundry appliance.

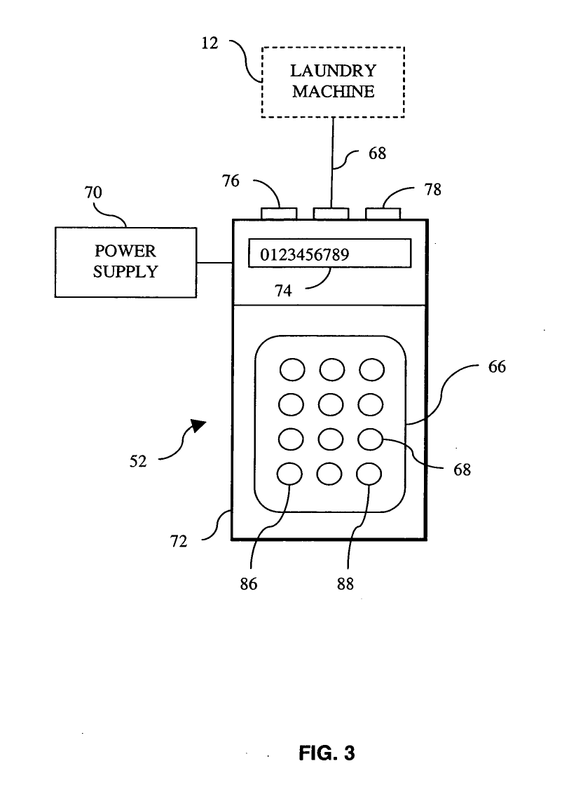

Referring now to FIG. 3, an exemplary embodiment of user association device 52 is shown. User association device 52 is shown as a keypad unit which includes a keypad 66 with buttons 58 for entering data, such as a telephone or extension number of the user, into keypad unit 52. Each keypad unit 52 includes a power supply 70. In FIG. 3, power supply 70 is shown to be external to keypad unit 52. Alternatively, power supply 70 may be contained within a housing 72 of keypad unit 52 or located at controller 56. Laundry appliance 12 is in communication with keypad unit 52 by physical connection 68. Connection 68 in a preferred embodiment is a connection between the diagnostic port of laundry appliance 12 and keypad unit 52 so that keypad unit 52 can monitor the voltage of the in use or running diagnostic signal of electronics 13 of laundry appliance 12. When laundry appliance 12 is in use the voltage of the signal is 5 VDC. When laundry appliance 12 is not in use or done with its tasks the voltage of the signal is 0 VDC. As such by monitoring the voltage of the appliance's diagnostic signal, keypad unit 52 is able to determine if laundry appliance 12 is in use or not in use. It should be understood that by further integrating keypad unit 52 with electronics 13 of appliance 12 further status information may be obtained about laundry appliance 12, such as cycle type (wash, spin, rinse), time left in cycle, equipment failure, or premature stoppage such as due to a lid of the laundry appliance being opened.

Connection 68 may be a data cable configured for sending and receiving signals between laundry appliance 12 and keypad unit 52. Further, laundry appliance 12 and keypad unit 52 may include transceivers to send and receive signals using a wireless protocol, such as infrared, IEEE 802.11a, 802.11b, or 802.11g, or BLUETOOTH™ communication protocol or the like. Once the laundry appliance 12 has completed its cycle, a done signal is received via connection 68 and sent through serial out connection 60 to the controller (not shown). In an alternative embodiment, the determination of whether laundry appliance 12 is in-use may be determined by monitoring the power usage of laundry appliance 12.

Keypad unit 52 further includes a display 74, input connection 76 and output connection 78. Display 74 provides test prompts to a user and displays inputs to keypad 66 from a user.

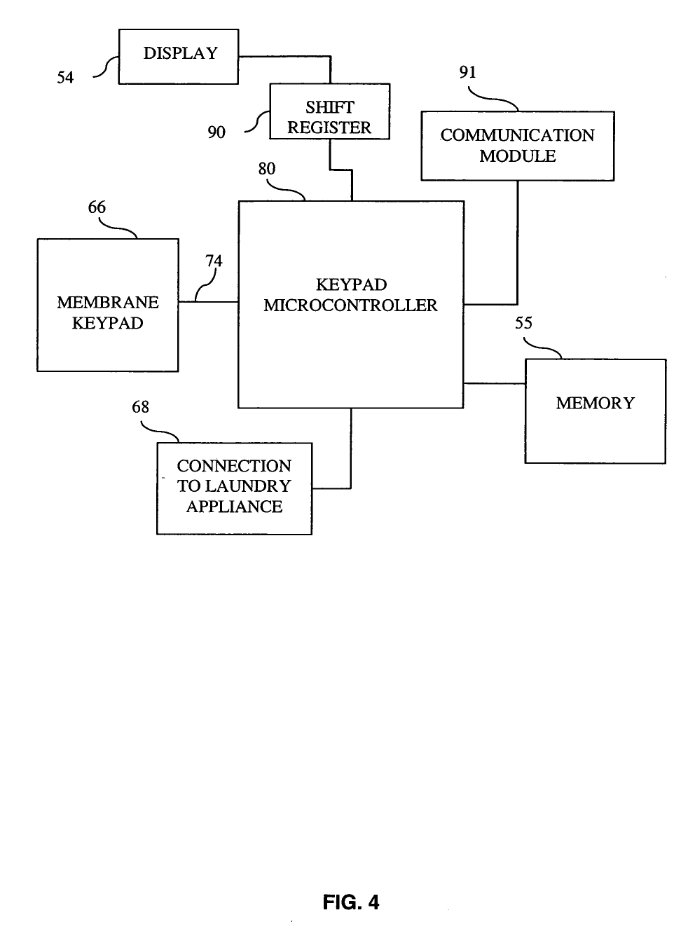

Referring now to FIG. 4, an exemplary embodiment of keypad 52 is shown. A keypad microcontroller 80, such as a PIC16F876 available from Microchip® located at 2355 West Chandler Blvd. Chandler, Ariz., USA 85224-6199 for example or similar microcontroller, is configured to determine a status of laundry appliance 12, such as whether laundry appliance 12 has completed a task that corresponds to laundry appliance being in use. In an alternative embodiment controller 80 receives a coin pulse or signal from laundry appliance 12 or an in-use pulse or signal indicating that the laundry appliance 12 has begun or is currently engaged in a laundry cycle or requested task. Pay laundry appliances may utilize the “coin pulse”-type signal or “in-use”-type signal and non-pay laundry appliances may utilize the “in-use”-type signal.

Once an in-use condition or a requested task has been commenced over connection 68 is detected by microcontroller 80, the microcontroller 80 prompts the user for a telephone number or an indication to cancel the alert process through LCD display 54. A user may then either input a numeric sequence followed by an enter key 86 (FIG. 3) or choose to cancel the alert process if they do not wish to receive notification that the laundry cycle is complete by depressing a cancel key 88 (FIG. 3). The number entered is stored in a memory 55 of the microcontroller 80. Shift register 90 is used to communicate the number entered to the LCD display 54. In one embodiment, the operation of laundry appliance 12 is dependent of the laundry alert system such that the operation of laundry appliance 12 is suspended until the user enters contact information or cancels the alert system. In another embodiment, the operation of laundry appliance 12 is independent of the laundry alert system such that the operation of laundry appliance 12 continues regardless of whether the user enters contact information or cancels the alert system.

The contact information is presented on display 74, in order to allow the user to verify that the proper contact information has been processed by user association device 52. Keypad unit 52 is further configured to in response to a done condition or completion of the requested task by laundry appliance 12 to transfer the contact information to controller 56 which in turn alerts the user that the laundry cycle is complete. The contact information is sent to controller 56 with a communication module 91. In one example, communications module 91 is configured to send a message to controller 56 over an RS-485 network.

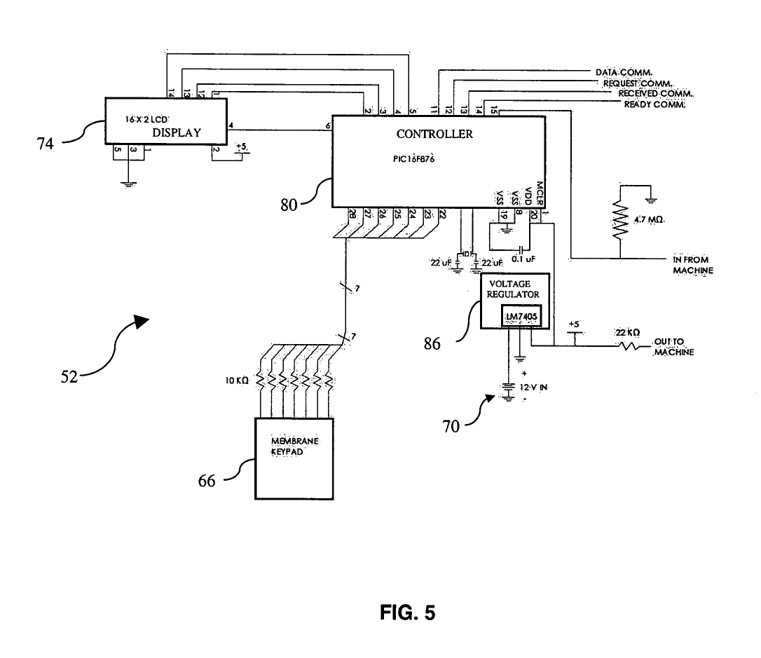

Referring now to FIG. 5, a schematic diagram of a first exemplary embodiment of user association device 52 is shown. Membrane keypad 66 is connected to keypad microcontroller 80, in this example a PIC16F876 controller available from Microchip® located at 2355 West Chandler Blvd. Chandler, Ariz., USA 85224-6199, in order to allow the user to input telephone number or contact information to microcontroller 80. Microcontroller 80 places the input data into a shift register and sends the data to LCD display 74 for the user to review for accuracy. Further the contact information is stored in memory 55.

Power for user association device 52 is provided via a power supply. In this exemplary embodiment, power to user association device 52 is regulated to 5VDC by voltage regulator 86. However, other power sources can also be utilized including such devices as internal or external batteries or the like.

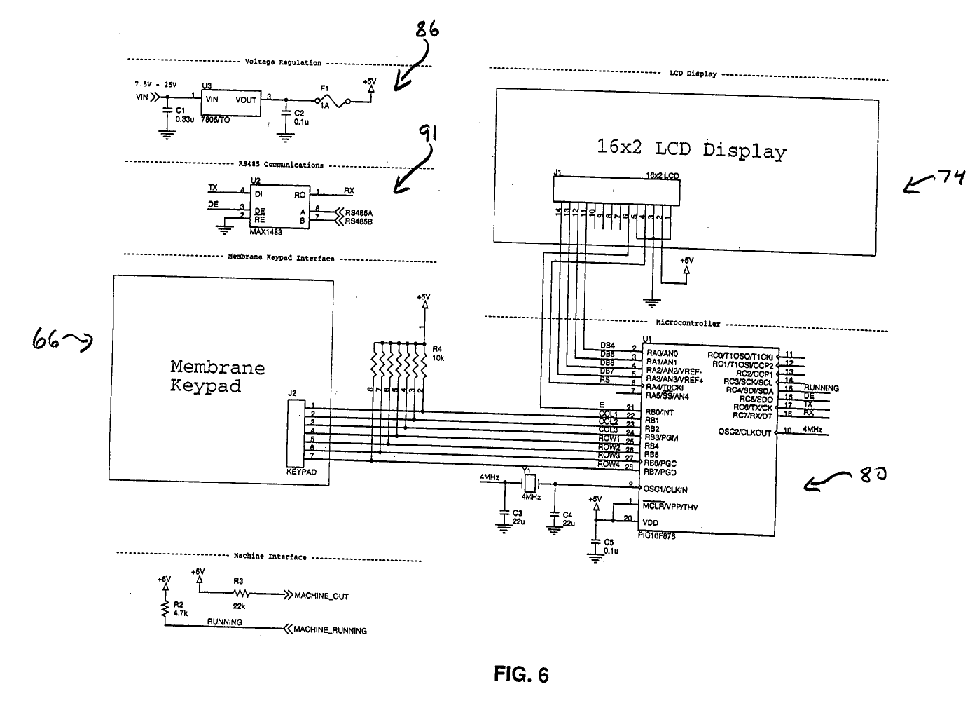

Referring now to FIG. 6, a schematic diagram of a second exemplary embodiment of user association device 52 is shown. Membrane keypad 66 is connected to keypad microcontroller 80, in this example a PIC16F876 controller available from Microchip® located at 2355 West Chandler Blvd. Chandler, Ariz., USA 85224-6199, in order to allow the user to input telephone number or contact information to microcontroller 80. Microcontroller 80 places the input data into a shift register and sends the data to LCD display 74 for the user to review for accuracy. Further the contact information is stored in memory 55.

Power for user association device 52 is provided via a power supply. In this exemplary embodiment, power to user association device 52 is regulated to 5VDC by voltage regulator 86. Communication module 91 is shown as being configured for an RS-485 network and includes a MAX1483 controller available from Maxim Integrated Products located at 120 San Gabriel Drive, Sunnyvale, Calif. 94086.

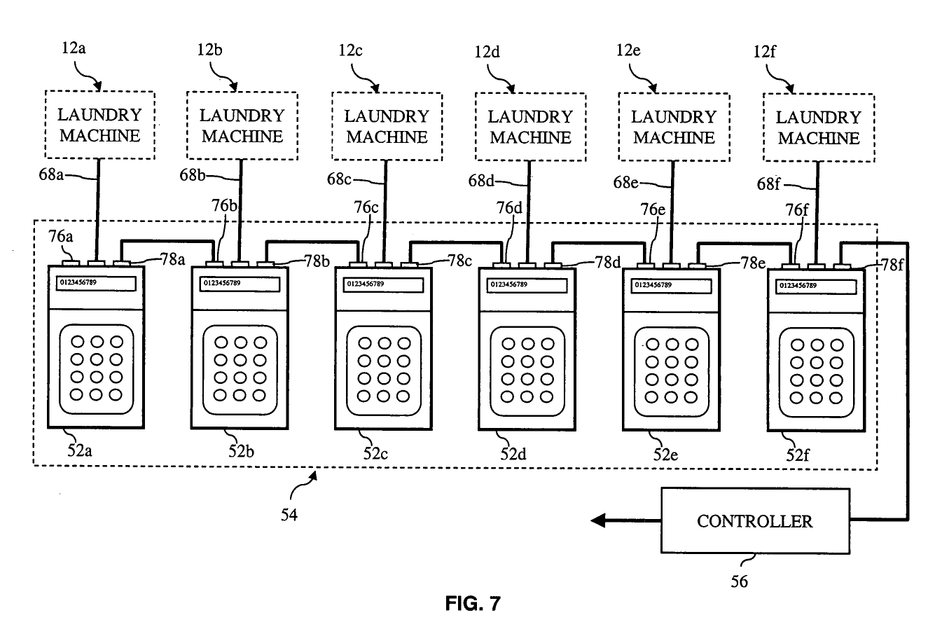

Referring now to FIG. 7, user association device array 54 is shown, each user association device 52 being coupled to a perspective one of the plurality of laundry appliances 12. As shown in FIG. 7, user association devices 52 are connected in series or “daisy-chained”. The output connection 78 of one user association device 52 is connected to the input connection 76 of the adjacent user association device 52. It should be appreciated that the user association devices 52 can be connected to controller 56 in a multitude of ways as long as each user association device 52 is able to communicate user contact information and status information to controller 56. In one embodiment, two hundred fifty-six (256) user association devices 52 are in the array 54 and communicate over a RS-485 network with controller 56.

When an individual keypad unit 52, for example keypad unit 52a, receives phone number or contact information from a user of a particular laundry appliance 12, such as laundry appliance 12a, the phone number of contact information is stored in memory 55 for later transmission to controller 56 with status information about laundry appliance 12 or immediately forwarded on to controller 56. In one example, upon completion of a laundry operation user association device 52 recognized a done or completed task status of the associated laundry appliance 12, and forwards the contact information through the keypad array 54 until it reaches controller 56 which then contacts the user and provides notification that the laundry cycle is complete. As stated above, the status condition and the user data may be sent contemporaneously or separately either at the time of entry, the time the laundry operation finishes, or sometime in between those two times. The status information and the user data are carried across the chain of keypad units 52 until they reach controller 56. In one example, the reception of user data by controller 56 serves as the indication that the laundry appliance has completed the requested task.

For example, after keypad unit 52a receives both the user contact information data from the user and detects the done or completed task condition from laundry appliance 12a, that data (contact and status or contact) is sent through serial out connection 78a and into keypad unit 52b via connection 76b. The data passes through each keypad unit 52 through its associated serial port 78 and into the next keypad unit 52 in the chain via connection 62. In the example shown in FIG. 7, keypad unit 52b sends the data through serial out connection 78b to connection 76c on keypad unit 52c. Keypad unit 52c then sends the data through serial port 78c to connection 76d on keypad unit 52d. Keypad unit 52d then sends the data through serial port 78d to connection 76e on keypad unit 52e. Keypad unit 52e then sends the data through serial port 78e to connection 76f on keypad unit 52f. Finally, keypad unit 52f sends the data through serial port 78f to controller 56, which communicates with the user associated with keypad unit 52a using the input user contact information and notifies the user that the laundry cycle associated with laundry appliance 12a is complete, as described in greater detail below.

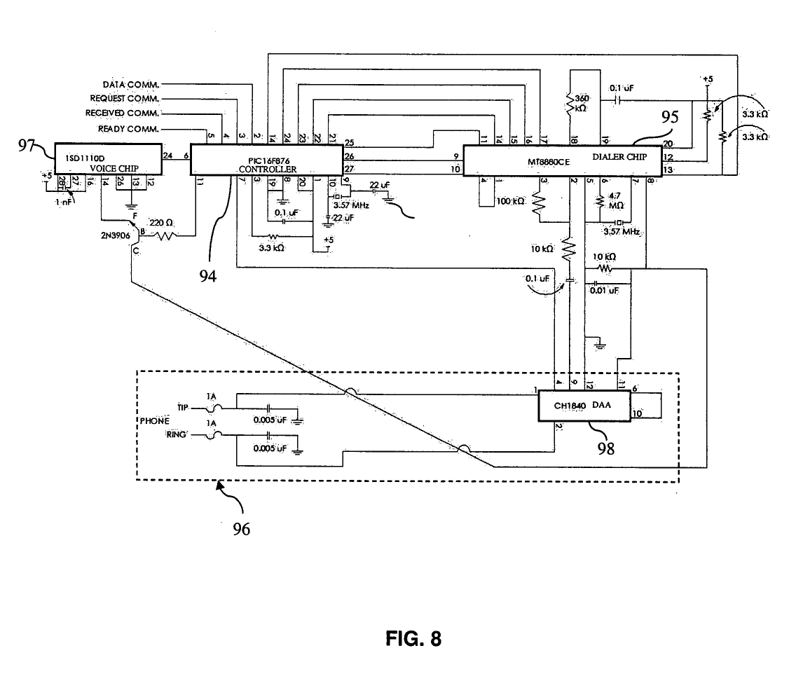

Referring now to FIG. 8, a schematic diagram of a first exemplary embodiment of controller 56 is shown. A microcontroller 94, such as a PIC16F876 controller available from Microchip® located at 2355 West Chandler Blvd. Chandler, Ariz., USA 85224-6199, is configured to accept phone number or extension number data and a laundry cycle done signal from a keypad unit (not shown), as described above and to begin a user notification process.

During the user notification process, microcontroller 94 utilizes the phone number or extension number data previously entered to direct a dialer chip 95 and the phone interface 96 to dial the number previously entered by the user. In an exemplary embodiment, the dialer chip 95 that is used is a ZARLINK™ Semiconductor MT8880C available from ZARLINK™ located at 10815 Rancho Bernardo Road Suite 210 San Diego, Calif. 92127 or equivalent and a CERMETEK™ Microelectronics CH1840 Data Access Arrangement (“DAA”) module 98 avaialbe from CERMETEK™ located at 406 Tasman Drive, Sunnyville, Calif. 94089 or equivalent that is included as a portion of the telephone interface 96. After dialing has commenced, microcontroller 94 waits for the dialer chip 95 to signal that the connection has been completed and directs voice chip 97 to play a prerecorded message alerting the user that the laundry cycle is complete. In an exemplary embodiment, the voice chip 97 is an ISD1110, produced by WinBond Electronics Corporation located at 800 Turnpike Street, Suite 300, North Andover, Mass., or its equivalent. The prerecorded message that is played by voice chip 97 can be either a generic message appropriate to any user or a customized message directed to the particular user who requested the notification.

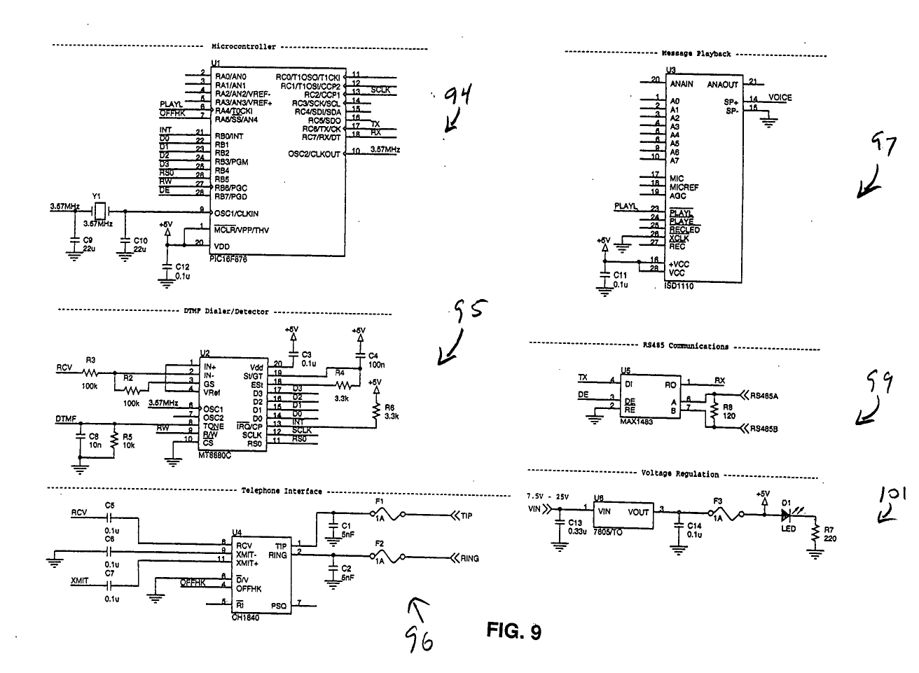

Referring now to FIG. 9, a schematic diagram of a second exemplary embodiment of controller 56 is shown. The second schematic embodiment is generally similar to the first schematic embodiment, but further includes a communication module 99 is shown as being configured for an RS-485 network and includes a MAX1483 controller available from Maxim Integrated Products located at 120 San Gabriel Drive, Sunnyvale, Calif. 94086. Also, provided is a voltage regulator 101 to regulate the power to controller 56.

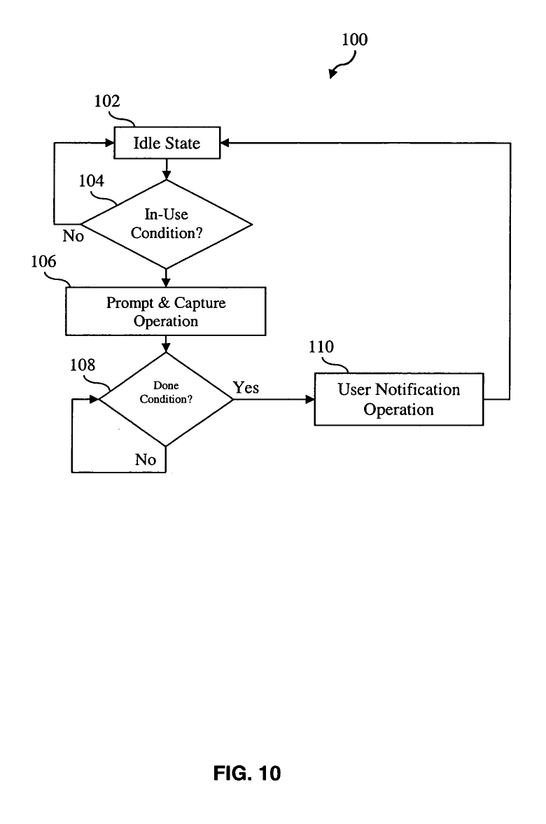

Referring to FIGS. 10-12, various exemplary methods of alerting a user of the status of an appliance are shown. Each of the exemplary methods are carried out by the respective user association devices 16 and/or controller 18 and are embodied in software and/or firmware associated with user association devices 16 and/or controller 18. In the case of software, the software is stored on one or more computer readable media which are accessible by user association devices 16 and/or controller 18.

Referring now to FIG. 10, an exemplary method 100 of alerting a user of the status of an appliance is shown. The method is described in connection with a single appliance 12 and a single user. however, as discussed herein in one embodiment several appliances 12 are monitored by the disclosed laundry alert systems. The illustrated method may be used to communicate to a user that a laundry appliance has completed a requested operation, such as washing clothing or drying clothing.

As represented by block 102, the system remains in an idle state until it recognizes an “in-use” condition such as the commencement of a requested task of appliance 12. In one example, the system recognizes the “in-use” condition by user association device 16 detection of a parameter of appliance 12, such as a voltage. In another example, the system recognizes the “in-use” condition by user association device 16 receiving a signal from appliance 12 indicative of the operation of the appliance 12. The “in-use” condition is an indication that a utilization of the appliance is being requested or commenced. Once an “in-use” condition has been identified, as represented by block 104, a prompt and capture operation is initiated as represented by block 106.

The prompt and capture routine prompts the user for a user input which is used as or provide contact information for the user and captures or stores the user input in a memory for future use. The user input may be stored locally at the user association device 16 or forwarded onto controller 18. In one example the user input is a telephone number that the user wishes to be notified at of the status of appliance 12.

In one embodiment, the operation of appliance 12 is stopped or otherwise suspended until the completion of the prompt and capture operation. In another embodiment, the operation of appliance 12 continues regardless of the completion of the prompt and capture operation. In such an embodiment, the prompt and capture operation may have a timeout feature or require an input to initiate.

Once the prompt and capture operation is completed, the system waits for a done condition, as represented by block 108. As stated herein the done condition communicates to user association device 16 that the appliance has completed its requested task. In one example, the system recognizes the done condition by user association device 16 detection of a parameter of appliance 12, such as a voltage. In another example, the system recognizes the done condition by user association device 16 receiving a signal from appliance 12 indicative of the operation of the appliance 12.

Once the done condition has been detected, the system initiates a user notification operation, as represented by block 110. User notification operation 110 provides notification to the user of the status of appliance 12. In one embodiment, user notification operation initiates a telephone call to a telephone number provided by the user during the prompt and capture operation and communicates the status of appliance 12 during the telephone call.

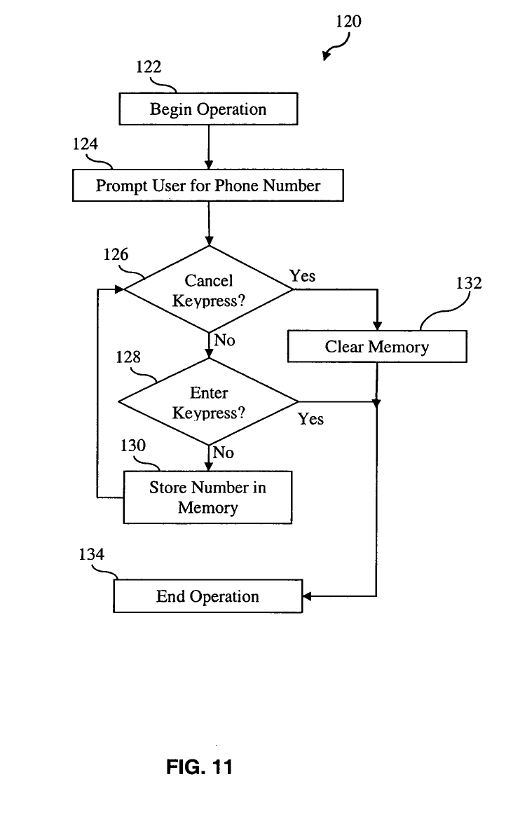

Referring to FIG. 11, one exemplary prompt and capture operation 120 is illustrated, prompt and capture operation 120 being designed to receive a phone number from the user. In step 122, the prompt and capture operation is began. As represented in block 124, the user is prompted to enter a phone number. In one example, the user prompt is provided through a display, such as an LCD display. In alternative examples, the user prompt is provided through a annunciator, such as a speaker.

In one example, user association device 16 includes a keypad. As represented by block 126, the system determines whether the user has depressed the Cancel key on the keypad. If the user depresses the Cancel key, then prompt and capture operation 120 is cancelled as represented by block 134. Also, in one example a shift register or memory associated with user association device 132 is cleared as represented by block 132.

If the user did not depress the Cancel key, the system next determines whether the user depressed the Enter key, as represented by block 128. If the user depressed the Enter key then it is assumed that the user has entered his/her phone number and prompt and capture operation 120 is completed as represented by block 134. If the user depressed a number key instead of the Enter key, the selected number is placed in the memory and the operation is returned to block 126. If the user continues to enter numeric data, the system subsequently places that data into the shift register at step 130. In this manner a user may input his/her telephone number into the system. In alternative examples, the keypad includes letter keys and a user may input other contact information such as an e-mail address. The phone number can be either a local 7-digit or 10-digit number including an area code, or it could be an extension number corresponding to a local telephone network.

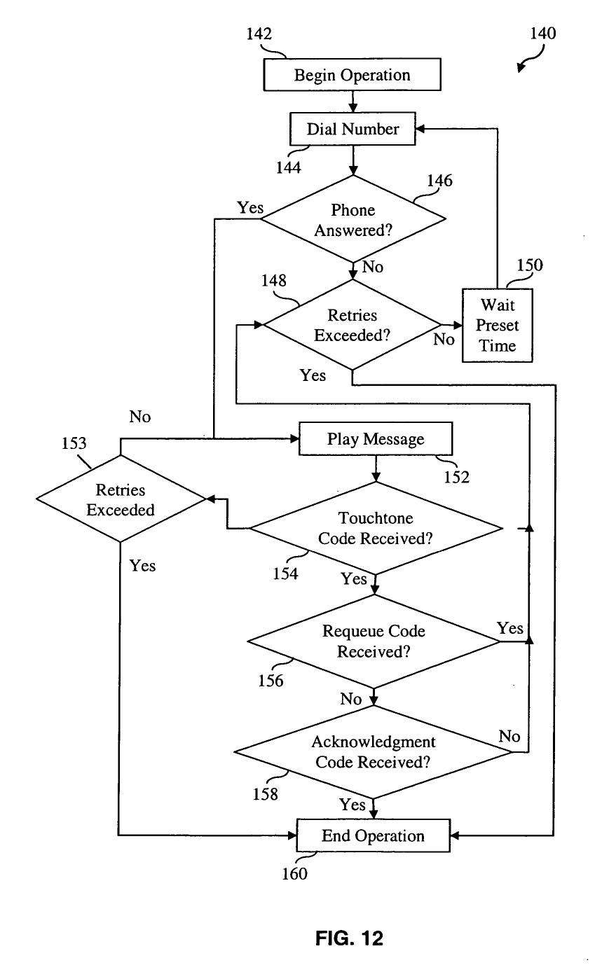

Referring now to FIG. 12, an exemplary user notification operation 140 is illustrated. User notification operation 140 being designed to initiate a telephone call to the user and present the user with a communication, such as a prerecorded message, indicating the status of appliance 12. As represented by block 142, the prompt and capture operation is began. As represented by block 144, the system initiates a telephone call to the user. The telephone number to be called being provided by the user during the prompt and capture operation, such as prompt and capture operation 120. The system then waits to determine if the dialed phone has been answered, as represented by block 146. If the dialed phone is not answered, the system determines if the number of phone retries exceeds a preset maximum number of phone retries, as represented by block 148. If the maximum number of phone retries is exceeded, the system ends the notification operation 140, as represented by block 160. Otherwise, the system waits a preset length of time, as represented by block 150, and then returns to block 144 to dial the telephone number again. In one example, the number of retries is set to three.

In one example, the system is configurable to block the dialing of various telephone numbers, such as telephone numbers which would incur additional costs. One example would be a telephone number for a land phone in another area code.

Returning to block 146, if an answer is detected, the system plays a user notification message, as represented by block 152, and waits a predetermined amount of time to detect if the user has depressed a key on his/her phone which in turn generates a touchtone code, as represented by block 154. If no touchtone code is detected, the system repeats the message unless a the message has already been repeated a maximum number of times, as represented by blocks 153 and 152. In one example, the message is repeated up to three times. If there is no touchtone and the maximum number of message replays is exceeded then the user notification operation ends as represented by block 160.

If a touchtone is received, the system checks to see if the touchtone corresponds to a re-queue request, as represented by block 156. In one example, a re-queue request is initiated by selecting a preset key such as the number 7. In one example, the message presented to the user includes instructions related to which key corresponds to the re-queue request. If the re-queue request is detected, the system returns to block 148 and queues the call again. In one example a variable associated with the number of retries is reset so that the user is guaranteed at least one subsequent call.

A re-queue request is useful if the user is not ready to return to the laundry appliance at that time, but would still like a notification at a later time. In one example the user is able to select the delay for the re-queue request with the keys on their phone.

If the received touchtone does not correspond to a re-queue request, the system checks to see if the touchtone corresponds to an acknowledgement request, as represented by block 158. In one example, an acknowledgement request is initiated by selecting a preset key such as the number 3. In one example, the message presented to the user includes instructions related to which key corresponds to the acknowledgement request. If the acknowledgement request is detected, the user notification operation is ended as represented by block 160. If the acknowledgement request is not detected, the system returns to block 148 and queues the call again. In one example a variable associated with the number of retries is reset so that the user is guaranteed at least one subsequent call.

Although the present invention has been described in detail with reference to preferred embodiments, variations and modifications exist within the scope and spirit of the present invention as described and defined in the following claims.

We claim:

1. A method of alerting a user over a network of a status of an appliance, the appliance being available to a plurality of users for use, the method comprising the steps of:
providing a controller operably coupled to the network and a user association device operably coupled to the controller, the user association device being associated with the appliance and operably coupled to the appliance;
detecting a commencement of a requested task associated with the appliance with the user association device;
prompting the user with the user association device for user contact information in response to the detection of the commencement of the requested task associated with the appliance;
receiving user contact information through an input of the user association device;
detecting a completion of the requested task by the appliance with the user association device; and
communicating to the user over the network the completion of the requested task, the user being contacted through the controller based in part on the user contact information.

2. The method of claim 1, wherein the network is a telephone network and the step of communicating to the user over the network the completion of the requested task comprises the steps of:
placing a telephone number corresponding to the user contact information in a queue;
establishing a telephone connection by dialing the telephone number; and
playing a prerecorded message.

3. The method of claim 2, further comprising the steps of:
receiving an acknowledgement from the user over the telephone connection; and
removing the telephone number from the queue.

4. The method of claim 2, further comprising the steps of:
receiving a request from the user to requeue the message;
placing the telephone number back in the queue for subsequent dialing;
establishing a telephone connection by dialing the telephone number; and
replaying the prerecorded message.

5. The method of claim 2, further comprising the steps of:
waiting a predetermined period of time; and
in the absence of receiving an acknowledgement from the user over the telephone network replaying the prerecorded message.

6. An apparatus for use with an appliance, the appliance being available for use by a plurality of users, the apparatus configured to alert a current user of the appliance over a telephone network of a status of the appliance, the appliance including a control circuit which indicates the status of the appliance, the apparatus comprising:
a controller adapted to be operably coupled to the telephone network;
a keypad unit operably coupled to the controller, the keypad unit including a keypad configured to permit the entry of a numeric sequence and a memory designed to store the numeric sequence, the keypad unit configured to communicate the numeric sequence to the controller;
wherein the keypad unit is further operably coupled to the control circuit in the appliance and is configured to determine whether the appliance has commenced a requested task and to determine if the requested task has been completed, the keypad unit being further configured to prompt the user for entry of the numeric sequence in response to appliance commencing the requested task and to provide the numeric sequence to the controller in response to a determination that the requested task has been completed by the appliance; and
wherein the controller, in response to receipt of the numeric sequence from the keypad unit, is configured to initiate a call over the telephone network based on the numeric sequence and to provide the current user a notification of the completion of the requested task by the appliance during the call.

7. The apparatus of claim 6, wherein the controller is further configured to receive an acknowledgment from the user that the notification was received, the acknowledgement corresponding to a first specific key tone received from the user.

8. The apparatus of claim 7, wherein the provided notification includes the playing of a prerecorded message.

9. The apparatus of claim 8, wherein in the absence of the acknowledgement the controller is configured to replay the prerecorded message again.

10. The apparatus of claim 8, wherein in the absence of the acknowledgement the controller is configured to disconnect the call and to initiate a second call over the telephone network based on the numeric sequence at a later time and to replay the prerecorded message during the second call.

11. The apparatus of claim 7, wherein the controller is further configured to receive a request to requeue the call, the request to requeue corresponding to a second specific key tone received from the user, the controller further configured to requeue the call for a later time in response to the received second specific key tone.

12. An apparatus for use with an appliance, the appliance being available for use by a plurality of users, the apparatus configured to alert a current user over a network of a status of the appliance, the apparatus comprising:
a controller adapted to be operably coupled to a network;
a user association device, the user association device being associated with and operably coupled to the appliance and being operably coupled to the controller, and
wherein the user association device is configured to prompt the current user of the appliance for a user contact input including user contact information upon detection of a commencement of a requested task by the appliance, to make the received user contact information available to the controller, and to provide an indication of the completion of the requested task by the appliance to the controller, the controller being configured to send a communication to the current user over the network based on the user contact information in response to the received indication of the completion of the requested task, the communication being configured to alert the user of the completion of the requested task by the appliance, and to resend the communication to the user in the absence of an acknowledgement of the communication from the user.

13. The apparatus of claim 12, wherein the communication includes a prerecorded telephone message.

14. The apparatus of claim 12, wherein the user contact information is representative of a telephone number.

15. The apparatus of claim 12, wherein the user contact information is representative of a request to not receive notification over the network.

16. The apparatus of claim 12, wherein the user association device is generally proximate to the appliance, and includes a keypad having at least a plurality of numeric keys and a cancel key.

17. The apparatus of claim 16, wherein the user contact information corresponds to a telephone number entered by the user through the keypad with at least the numeric keys.

18. The apparatus of claim 16, wherein the user contact information corresponds to a request to not receive notification over the network entered by the user through the keypad with at least the cancel key.

19. The apparatus of claim 16, wherein the user contact information is representative of a telephone number and the controller is further configured to distinguish a request to requeue the communication received over the network from the user and to requeue the communication for sending at a later time.

20. An apparatus for use with an appliance, the appliance for use by a plurality of users, the apparatus configured to alert a current user over a network of a status of the appliance, the apparatus comprising:
a controller adapted to be operably coupled to the network; and
a user association device operably coupled to the controller, the user association device being configured to prompt the user of the appliance for an input, the input being indicative of a network identifier for the user, the user association device being further configured to provide an indication of a completion of a requested task to the controller; wherein the controller is configured based on the input and the received indication of the completion of the requested task to initiate a first communication to the user over the network to alert the user of the status of the appliance and is further configured to send a second communication to the user over the network in response to the reception of a request from the user to send the second communication.

21. The apparatus of claim 20, wherein the first communication includes a prerecorded telephone message.

22. The apparatus of claim 20, wherein the network identifier is representative of a telephone number.

23. The apparatus of claim 20, wherein each of the user association devices includes a keypad.
